(19) United States
(12) Patent Application Publication
(10) Pub. No.: US 2021/0345848 A1
(43) Pub. Date: Nov. 11, 2021

(54) VACUUM CLEANER HOLDING APPARATUS AND VACUUM CLEANING APPARATUS HAVING SAME

(71) Applicant: Samsung Electronics Co., Ltd., Suwon-si, Gyeonggi-do (KR)

(72) Inventors: Kyong Hui JEON, Suwon-si, (KR); Sang-Woo LEE, Suwon (KR)

(21) Appl. No.: 17/250,754

(22) PCT Filed: Jun. 28, 2019
(86) PCT No.: PCT/KR2019/007889

§ 371 Date: Mar. 1, 2021

(30) Foreign Application Priority Data
Aug. 30, 2018 (KR) 10-2018-0102611

(51) Int. Cl. A47L 9/28; A47L 9/00; A47L 5/28; H01M 10/46; H02J 7/00

(52) U.S. Cl. CPC A47L 9/2873; A47L 9/0063; A47L 9/2884; H01M 2220/30; H01M 10/46; H02J 7/0044; A47L 5/28

(57) ABSTRACT

Disclosed is a vacuum cleaner holding apparatus. The disclosed vacuum cleaner holding apparatus comprises: a holder including a first charging terminal provided so as to be electrically, connectable to a vacuum cleaner equipped with a first battery; a base which includes a second charging terminal provided so as to be electrically connectable to a second battery, and which is provided to receive a first power adapter provided to supply power to the first charging terminal and a second power adapter provided to supply power to the second charging terminal; and a support connecting the holder and the base and having a cavity formed therein.

### CROSS-REFERENCE TO RELATED APPLICATIONS

This application is a 371 National Stage of International Application No. PCT/KR2019/007889, filed Jun. 28, 2019, which claims priority to Korean Patent Application No. 10-2018-0102611, filed Aug. 30, 2018, the disclosures of which are herein incorporated by reference in their entirety.

### BACKGROUND

### 1. Field

The present invention relates to a vacuum cleaner holding apparatus and a vacuum cleaning apparatus including the same, and more specifically, to a vacuum cleaner holding apparatus with an improved structure and a vacuum cleaning apparatus including the same.

### 2. Description of Related Art

Generally, vacuum cleaners are home appliances which use vacuum pressure generated by motors installed in vacuum cleaner bodies to suction air containing foreign materials such as dust and filter the foreign materials in the vacuum cleaner bodies.

A vacuum cleaner may include a motor configured to generate suction pressure and a suction unit configured to come into contact with a cleaning target surface using the suction pressure. The vacuum cleaners may be classified into canister-type vacuum cleaners, upright-type vacuum cleaners, hand-held-type vacuum cleaners, stick-type vacuum cleaners, and the like according to a form thereof.

A vacuum cleaning apparatus may include a vacuum cleaner and a vacuum cleaner holding apparatus provided to store the vacuum cleaner when use of the vacuum cleaner is finished. The vacuum cleaner holding apparatus may be provided to charge the held vacuum cleaner. An auxiliary battery used in the vacuum cleaner may be held and charged by the vacuum cleaner holding apparatus. The vacuum cleaner holding apparatus may receive power through a separate power adapter to sequentially charge the vacuum cleaner and the auxiliary battery.

### SUMMARY

The present invention is directed to providing a vacuum cleaner holding apparatus capable of charging both of a vacuum cleaner and an auxiliary battery and a vacuum cleaning apparatus having the same.

The present invention is also directed to providing a vacuum cleaner holding apparatus capable of stably holding a vacuum cleaner and a vacuum cleaning apparatus having the same.

One aspect of the present invention provides a vacuum cleaner holding apparatus including a holder which includes a first charging terminal provided to be electrically connectable to a vacuum cleaner in which a first battery is installed, a base which includes a second charging terminal provided to be electrically connectable to a second battery and accommodates a first power adapter provided to supply power to the first charging terminal and a second power adapter provided to supply power to the second charging terminal, and a support which connects the holder and the base and in which a hollow is formed.

Wires, which electrically connect the first power adapter and the first charging terminal, may be disposed in the hollow of the support.

The holder may include a first connecting device connected to the support, and the first connecting device may include a first wire guide which guides at least some of the wires passing through the hollow and extending to the holder.

The base may include a second connecting device connected to the support, and the second connecting device may include a second wire guide which guides at least some of the wires extending from the base to the hollow.

The second power adapter may be provided to be driven independently of the first power adapter.

The support may extend in a direction oblique to a bottom surface on which the base is disposed.

The support may extend upward from an edge of an upper surface of the base toward a center of the base.

A printed circuit board configured to control the first power adapter and the second power adapter may be disposed in the base.

The base may include a weight balancer provided to increase a weight of the base.

The base may include a battery accommodation part in which the second battery is accommodated to be electrically connected to the second charging terminal.

The holder may include a guide seating part which guides the first battery installed in the vacuum cleaner to a position at which the first battery is electrically connected to the first charging terminal when the vacuum cleaner is seated on the vacuum cleaner holding apparatus.

The support may include a connecting port provided to store an auxiliary suction unit of the vacuum cleaner.

The vacuum cleaner holding apparatus may further include a power cable which is provided to be connectable to the base to supply the power to the first power adapter and the second power adapter and of which one end opposite to the other end connected to the base is connected to a plug for receiving a source voltage.

The base may include a suction unit seating part provided to allow a main suction unit installed in the vacuum cleaner to be seated on the suction unit seating part.

Another aspect of the present invention provides a vacuum cleaning apparatus including a vacuum cleaner provided to allow a main suction unit and a first battery to be installable in the vacuum cleaner, and a vacuum cleaner holding apparatus on which the vacuum cleaner is held, wherein the vacuum cleaner holding apparatus includes a holder including a first charging terminal provided to be electrically connectable to the vacuum cleaner in which the first battery is installed, a base which includes a second charging terminal provided to be electrically connectable to a second battery and accommodates a first power adapter provided to supply power to the first charging terminal and a second power adapter provided to supply power to the second charging terminal, and a support which connects the holder and the base and in which a hollow is formed.

Wires, which electrically connect the first power adapter and the first charging terminal, may be disposed in the hollow of the support.

A printed circuit board configured to control the first power adapter and the second power adapter may be disposed in the base.

The printed circuit board may be provided to control both of the first power adapter and the second power adapter.

The support may extend in a direction oblique to a bottom surface on which the base is disposed.

Still another aspect of the present invention provides a vacuum cleaner holding apparatus including a holder which includes a first charging terminal provided to be electrically connectable to a vacuum cleaner in which a first battery is installed, a base which includes a second charging terminal provided to be electrically connectable to a second battery, and a support which connects the holder and the base and in which a hollow is formed, wherein the base includes a first power adapter provided to supply power to the first charging terminal, a second power adapter provided to supply power to the second charging terminal, and a printed circuit board provided to independently control the first power adapter and the second power adapter.

According to embodiments of the present invention, since a vacuum cleaner holding apparatus includes a first power adapter for charging a vacuum cleaner and a second power adapter for charging an auxiliary battery, both of the vacuum cleaner and the auxiliary battery can be charged.

In the vacuum cleaner holding apparatus, the first power adapter and the second power adapter are disposed in a base, a center of gravity is positioned at a lower portion, and thus the vacuum cleaner can be stably held.

In the vacuum cleaner holding apparatus, since a supporting member is obliquely disposed, the vacuum cleaner can be stably held.

### BRIEF DESCRIPTION OF THE DRAWINGS

FIG. 1 is a perspective view illustrating a vacuum cleaning apparatus according to one embodiment of the present invention.

FIG. 2 is a view illustrating the vacuum cleaner holding apparatus illustrated in FIG. 1.

FIG. 3 is an exploded view illustrating the vacuum cleaner holding apparatus illustrated in FIG. 2.

FIG. 4 is a view illustrating an interior of a base of the vacuum cleaner holding apparatus illustrated in FIG. 3.

FIG. 5 is a cross-sectional view illustrating a coupling portion of a holder and a support illustrated in FIG. 3.

FIG. 6 is a cross-sectional view illustrating a coupling portion of the support and the base illustrated in FIG. 3.

FIG. 7 is a schematic block diagram illustrating components for charging in the vacuum cleaner holding apparatus.

### DETAILED DESCRIPTION

Embodiments described in this specification and configurations illustrated in drawings are only exemplary examples of the disclosed invention. The invention covers various modifications that can be substituted for the embodiments and drawings herein at the time of filing of this application.

In addition, the same reference numerals or symbols refer to parts or components that perform substantially the same function.

In addition, the terms used in the present specification are merely used to describe the exemplary embodiments and are not intended to limit and/or restrict the embodiments. An expression used in the singular encompasses the expression of the plural unless it has a clearly different meaning in the context. In the present specification, the terms such as “including,” “having,” and “comprising” are intended to indicate the presence of the features, numbers, steps, actions, components, parts, or combinations thereof disclosed in the specification and are not intended to preclude the possibility that one or more other features, numbers, steps, actions, components, parts, or combinations thereof may be present or added.

In addition, it should be understood that, although the terms “first,” “second,” and the like may be used herein to describe various elements, these elements should not be limited by these terms. These terms are only used to distinguish one element from another element. For example, a first element could be termed a second element, and, similarly, a second element could be termed a first element, without departing from the scope of the present invention. As used herein, the term “and/or” includes one or combinations of the associated listed items.

Meanwhile, the terms used in the specification, such as “upper portion,” “lower portion,” and “front-rear direction,” and the like are defined based on the drawings, and shapes and positions of components are not limited to the terms.

Hereinafter, embodiments according to the present invention will be described in detail with reference to the accompanying drawings.

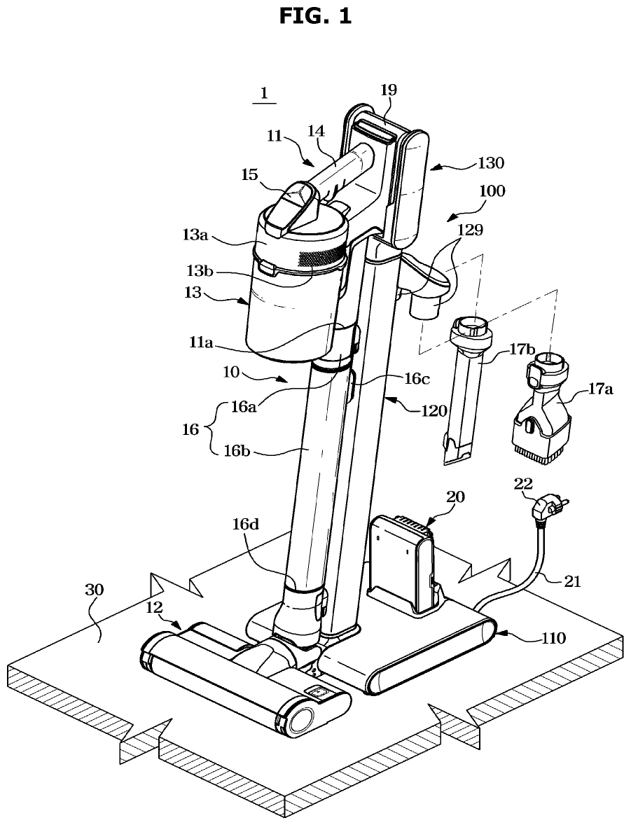

FIG. 1 is a perspective view illustrating a vacuum cleaning apparatus according to one embodiment of the present invention.

Referring to FIG. 1, a vacuum cleaning apparatus 1 may include a vacuum cleaner 10 and a vacuum cleaner holding apparatus 100.

The vacuum cleaner 10 may include a vacuum cleaner body 11, an extension pipe 16 detachably coupled to the vacuum cleaner body 11, a main suction unit 12 detachably coupled to the extension pipe 16, and a dust collector 13 detachably coupled to the vacuum cleaner body 11.

The vacuum cleaner body 11 may include a suction motor (not shown) configured to generate a suction force needed to suction foreign materials on a cleaning target surface and the dust collector 13 in which the foreign materials suctioned from the cleaning target surface are accommodated.

The dust collector 13 may be formed to be disposed at an upper stream side of an air flow than the suction motor to filter and collect dust in air or garbage introduced through the main suction unit 12. The dust collector 13 may be provided to be detachable from the vacuum cleaner body 11.

The vacuum cleaner 10 may include a filter housing 13a. The filter housing 13a may be formed to be substantially donut shaped to accommodate a filter (not shown) therein.

A type of the filter is not limited, and as an example, a high efficiency particulate filter (HEPA filter) may be disposed in the filter housing 13a. The filter may filter ultrafine dust and the like which is not filtered in the dust collector 13. The filter housing 13a may include a plurality of holes 13b so that air passing through the filter is discharged to the outside of the vacuum cleaner 10.

The vacuum cleaner body 11 may include a handle 14 so that a user grips the handle 14 to manipulate the vacuum cleaner 10. The user may grip the handle 14 to move the vacuum cleaner 10 in a front-rear direction.

The vacuum cleaner body 11 may include a control part 15. The user may manipulate a power button and the like provided on the control part 15 to turn the vacuum cleaner 10 on or off or adjust a suction force thereof.

The main suction unit 12 may be formed to come into contact with the cleaning target surface. The main suction unit 12 may be provided to come into contact with the cleaning target surface to suction foreign materials such as dust present on the cleaning target surface.

The main suction unit 12 and the vacuum cleaner body 11 may be connected through the extension pipe 16. One end of the extension pipe 16 may be pivotally connected to the main suction unit 12 to allow the main suction unit 12 to perform a joint motion with respect to the extension pipe 16.

The extension pipe 16 may include a first extension pipe 16a, a second extension pipe 16b, and a length adjusting part 16c. The length adjusting part 16c may be provided to adjust a length by which the second extension pipe 16b is exposed to the outside. Since the length adjusting part 16c adjusts a total length of the extension pipe 16, the user may perform cleaning work using the extension pipe 16 with a proper length. Accordingly, the usage convenience of the vacuum cleaner 10 may be improved.

The vacuum cleaner body 11 may include an extension pipe connecting part 11a. The extension pipe connecting part 11a may be provided to separate the extension pipe 16 from the vacuum cleaner body 11 or couple the extension pipe 16 to the vacuum cleaner body 11.

A suction unit connecting part 16d may be provided at the other end portion opposite to one end portion, which is connected to the vacuum cleaner body 11, of the extension pipe 16. The suction unit connecting part 16d may be provided to separate the main suction unit 12 from the vacuum cleaner body 11 or couple the main suction unit 12 to the vacuum cleaner body 11. Auxiliary suction units 17a and 17b may be detachably coupled to the suction unit connecting part 16d.

The main suction unit 12 may be replaced with the auxiliary suction unit 17a or 17b in the vacuum cleaner 10 according to a state of the cleaning target surface. As an example, the auxiliary suction units 17a and 17b may include the auxiliary suction unit 17a provided to include a brush and the auxiliary suction unit 17b formed in a shape of which an entrance is narrowly formed to clean a narrow gap.

The auxiliary suction units 17a and 17b may be stored in a connecting port 129 of the vacuum cleaner holding apparatus 100 when not in use. The connecting port 129 may be provided on a support 120. The connecting port 129 may be formed to protrude rearward from an extension body 121 of the support 120 into which various types of the auxiliary suction units 17a and 17b may be fitted and stored therein.

The vacuum cleaner 10 may include a first battery 19 for providing a driving force to the vacuum cleaner 10. The first battery 19 may be detachably installed in the vacuum cleaner body 11. The first battery 19 may be electrically connected to a first charging terminal 133 provided in the vacuum cleaner holding apparatus 100. The first battery 19 may be charged by receiving power from the first charging terminal 133 provided in the vacuum cleaner holding apparatus 100.

The vacuum cleaning apparatus 1 may include a second battery 20. The second battery 20 is a spare battery, and the user may replace the first battery 19 with the second battery 20 to continuously perform cleaning work after the first battery 19 installed in the vacuum cleaner 10 is discharged. Accordingly, an operation time of the vacuum cleaner 10 may be increased.

The vacuum cleaner holding apparatus 100 may be formed so that the vacuum cleaner 10 is stored or held thereby. The vacuum cleaner 10 may be charged on the vacuum cleaner holding apparatus 100. The vacuum cleaner holding apparatus 100 may be supported by a bottom surface 30 through a base 110 disposed on the bottom surface 30.

The vacuum cleaner holding apparatus 100 may receive power through a power cable 21 provided with a plug 22 at one end thereof. The power cable 21 may be connected to a power input port 119 provided in a lower portion of the base 110 of the vacuum cleaner holding apparatus 100. The plug 22 may be connected to a power outlet (not shown). External power supplied through the power outlet may be supplied to the first power adapter 116 and the second power adapter 117 by sequentially passing through the plug 22, the power cable 21, and the power input port 119.

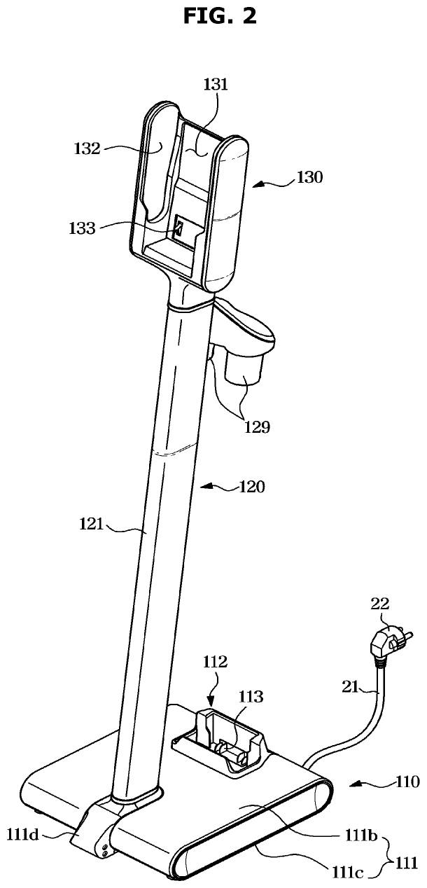

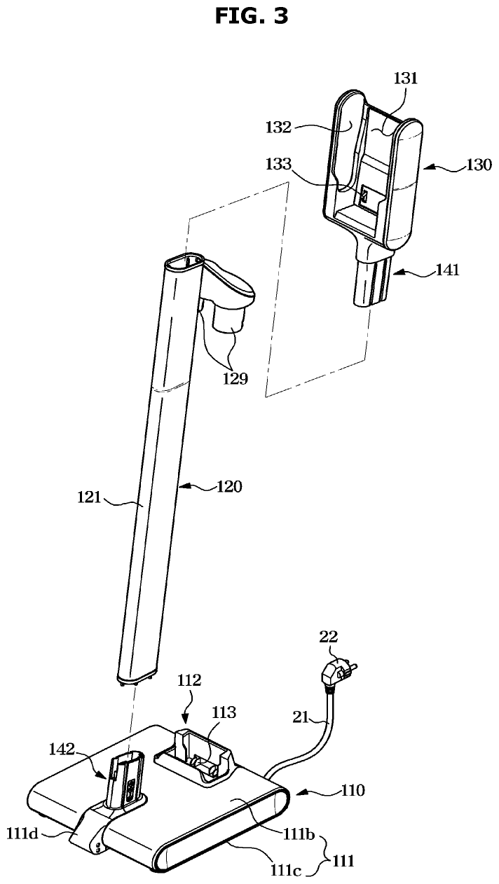

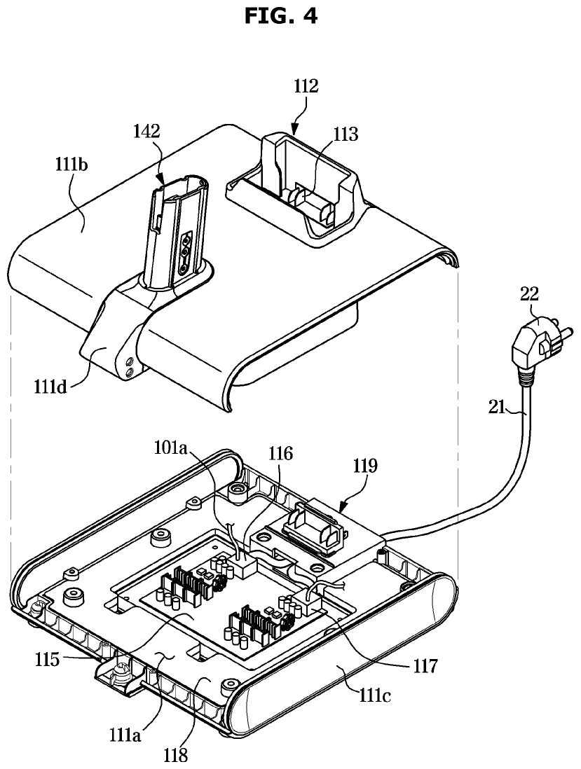

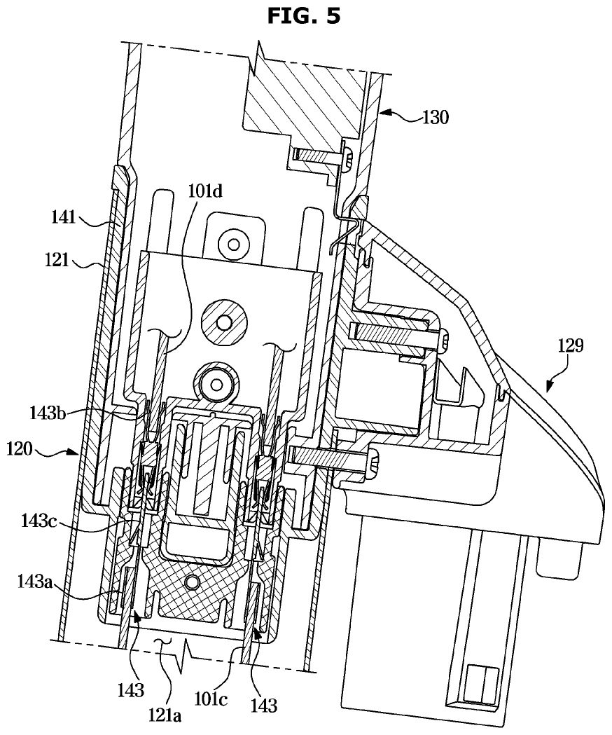

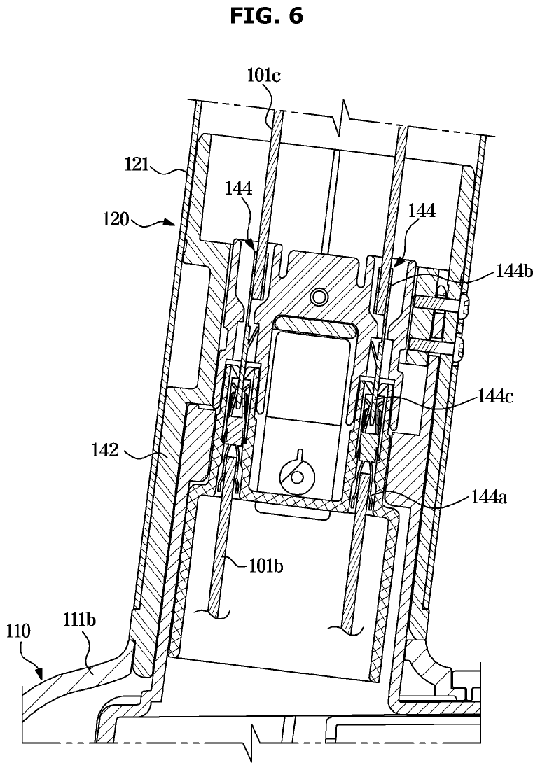

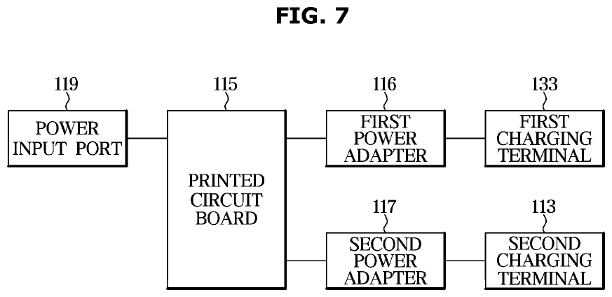

FIG. 2 is a view illustrating the vacuum cleaner holding apparatus illustrated in FIG. 1. FIG. 3 is an exploded view illustrating the vacuum cleaner holding apparatus illustrated in FIG. 2. FIG. 4 is a view illustrating an interior of the base of the vacuum cleaner holding apparatus illustrated in FIG. 3. FIG. 5 is a cross-sectional view illustrating a coupling portion of a holder and the support illustrated in FIG. 3. FIG. 6 is a cross-sectional view illustrating a coupling portion of the support and the base illustrated in FIG. 3. FIG. 7 is a schematic block diagram illustrating components for charging in the vacuum cleaner holding apparatus.

Referring to FIGS. 2 and 3, the vacuum cleaner holding apparatus 100 may be formed so that the vacuum cleaner 10 is stored or charged. The vacuum cleaner 10 may be held by the vacuum cleaner holding apparatus 100. The vacuum cleaner holding apparatus 100 may include the base 110, the support 120, and a holder 130.

The base 110 may extend in a direction substantially parallel to the bottom surface 30 so that the vacuum cleaner holding apparatus 100 is supported by the bottom surface 30. The base 110 may include a base cover 111 and a battery accommodation part 112.

Referring to FIG. 4, the base cover 111 may form an exterior of the base 110. The base cover 111 may include an accommodation space 111a formed therein. A printed circuit board (PCB) 115, a first power adapter 116, and a second power adapter 117 may be disposed in the accommodation space 111a. The base cover 111 may include an upper cover 111b and a lower cover 111c. The accommodation space 111a may be formed between the upper cover 111b and the lower cover 111c.

The base cover 111 may include a suction unit seating part 111d for stably supporting the main suction unit 12 installed in the vacuum cleaner 10 when the vacuum cleaner 10 is held by the vacuum cleaner holding apparatus 100. The main suction unit 12 may be stored on the vacuum cleaner holding apparatus 100 in a state in which the main suction unit 12 is seated on the suction unit seating part 111d.

The battery accommodation part 112 may be provided to accommodate the second battery 20 which is spared and is not installed in the vacuum cleaner 10. A second charging terminal 113 may be disposed in the battery accommodation part 112. The second battery 20 may receive power through the second charging terminal 113 in a state in which the second battery 20 is seated on the battery accommodation part 112.

The second charging terminal 113 may be provided to be electrically connected to the second battery 20 when the second battery 20 is accommodated in the battery accommodation part 112. The second charging terminal 113 may provide the power, which is received from the second power adapter 117, to the second battery 20.

The PCB 115 may be formed to control the first power adapter 116 and the second power adapter 117. The PCB 115 may be formed to control both of the first power adapter 116 and the second power adapter 117 to be driven. The PCB 115 may be provided to supply the power received through the power cable 21 to both of the first power adapter 116 and the second power adapter 117 to charge both of the first battery 19 of the vacuum cleaner 10 electrically connected to the first charging terminal 133 and the second battery 20 of the vacuum cleaner 10 electrically connected to the second charging terminal 113.

The first power adapter 116 may be provided to supply the power to the first charging terminal 133. The first power adapter 116 may receive the power, which is provided through the power cable 21, through the power input port 119. The first power adapter 116 may convert the power received through the power input port 119 and transmit the converted power to one connected wire 101a. The first power adapter 116 may be controlled by the PCB 115.

The second power adapter 117 may be provided to supply the power to the second charging terminal 113. The second power adapter 117 may receive the power, which is provided through the power cable 21, through the power input port 119. The second power adapter 117 may convert the power which is received through the power input port 119 and provide the converted power to the second charging terminal 113. The second power adapter 117 may be controlled by the PCB 115.

The first power adapter 116 may be provided to be driven independently of the second power adapter 117.

Specifically, referring to FIG. 7, when external power is supplied to the power input port 119 through the power cable 21, the PCB 115 may supply the power, which is supplied through the power input port 119, to the first power adapter 116 and the second power adapter 117. Since the first power adapter 116 and the second power adapter 117 are each electrically connected to the PCB 115, the first power adapter 116 and the second power adapter 117 may be independently driven. Due to such a structure, the first power adapter 116 may supply power to the first charging terminal 133 to charge the first battery 19 installed in the vacuum cleaner 10, and the second power adapter 117 may supply power to the second charging terminal 113 to charge the second battery 20 installed in the battery accommodation part 112.

A weight balancer 118 provided to increase a weight of the base 110 may be disposed in an accommodation space 111a of the base cover 111. The weight balancer 118 may increase the weight of the base 110 to allow the center of gravity of the vacuum cleaner holding apparatus 100 to be lowered further. Accordingly, the vacuum cleaner holding apparatus 100 may be stably supported by the bottom surface.

The support 120 may be formed to connect the base 110 and the holder 130. The support 120 may include the extension body 121 in which a hollow 121a is formed. One end of the extension body 121 may be detachably fixed to the base 110. The other end opposite to one end of the extension body 121 may be detachably fixed to the holder 130.

The extension body 121 may extend in a direction oblique to the bottom surface on which the base 110 is disposed. The extension body 121 may extend upward from an edge of an upper surface of the base 110 toward a center of the base 110. The extension body 121 may be provided to be inclined upward from a front end of the upper surface of the base 110 in a rearward direction. Accordingly, the vacuum cleaner holding apparatus 100 may be stably supported by the bottom surface due to the weight of the vacuum cleaner 10 even in a state in which the vacuum cleaner 10 is held by the vacuum cleaner holding apparatus 100.

Some wires 101b, 101c, and 101d which electrically connect the first power adapter 116 and the first charging terminal 133 may be disposed in the hollow 121a formed in the extension body 121. The wires 101a, 101b, 101c, and 101d extending from the first power adapter 116 may be guided to the first charging terminal 133 through the hollow 121a.

A first connecting device 141 may be disposed at a portion in which the extension body 121 and the holder 130 are connected. The first connecting device 141 may be provided in the holder 130. The first connecting device 141 may be fixedly inserted into the extension body 121 of the support 120.

Specifically, referring to FIG. 5, the first connecting device 141 may include a first wire guide 143 which guides at least some wires 101c and 101d extending in a direction from the hollow 121a to the holder 130. The first wire guide 143 may guide some wires 101c and 101d passing through the hollow 121a and extending to the first charging terminal 133 of the holder 130.

Specifically, the first wire guide 143 may include a first terminal part 143a electrically connected to one wire 101c disposed in the hollow 121a, a second terminal part 143b electrically connected to one wire 101d extending in a direction toward the holder 130, and a first connecting part 143c which electrically connects the first terminal part 143a and the second terminal part 143b. Accordingly, one wire 101c disposed in the hollow 121a and one wire 101d extending in the direction toward the holder 130 may be electrically connected.

A second connecting device 142 may be disposed in a portion in which the extension body 121 and the base 110 are connected. The second connecting device 142 may be provided in the base 110. The second connecting device 142 may be fixedly inserted into the extension body 121 of the support 120.

Specifically, referring to FIG. 6, the second connecting device 142 may include a second wire guide 144 which guides at least some wires 101b and 101c extending in a direction from the base 110 to the hollow 121a. The second wire guide 144 may guide one wire 101a extending from the first power adapter 116 of the base 110 in the direction to the hollow 121a of the support 120.

Specifically, the second wire guide 144 may include a third terminal part 144a electrically connected to one wire 101b extending in a direction from the first power adapter 116 toward the hollow 121a, a fourth terminal part 144b electrically connected to one wire 101c passing through the hollow 121a and extending toward the holder 130, and a second connecting part 144c electrically connecting the third terminal part 144a and the fourth terminal part 144b. Accordingly, one wire 101b extending from the first power adapter 116 and one wire 101c passing through the hollow 121a and extending toward the holder 130 may be electrically connected.

The support 120 may further include the connecting port 129 provided to store the auxiliary suction units 17a and 17b. The connecting port 129 may be provided so that the auxiliary suction units 17a and 17b are inserted thereinto. In FIG. 2, it is illustrated that two connecting ports 129 are provided, but the number of the connecting ports 129 is not limited thereto, and the number thereof may be variously provided to correspond to the number of the auxiliary suction units 17a and 17b. The connecting port 129 may protrude rearward from an upper end portion of the extension body 121 of the support 120 in consideration of accessibility of the user.

The holder 130 is provided to store the vacuum cleaner 10. The holder 130 may include a vacuum cleaner seating part 131 on which the vacuum cleaner 10 is seated, a guide seating part 132 on which the first battery 19 installed in the vacuum cleaner 10 is seated, and the first charging terminal 133 provided to be electrically connectable to the vacuum cleaner 10.

The vacuum cleaner seating part 131 may be provided to hold the vacuum cleaner 10. One portion of the vacuum cleaner body 11 and the first battery 19 may be seated on the vacuum cleaner seating part 131. The first charging terminal 133 may be disposed on the vacuum cleaner seating part 131.

The guide seating part 132 may guide the first battery 19 installed in the vacuum cleaner 10 to a position at which the first battery 19 is electrically connected to the first charging terminal 133 when the vacuum cleaner 10 is seated on the vacuum cleaner seating part 131. The guide seating part 132 may guide both side end portions of the first battery 19 in a direction in which the vacuum cleaner 10 is inserted into the vacuum cleaner seating part 131. A shape and/or a size of the guide seating part 132 may be provided to correspond to the first battery 19.

The first charging terminal 133 may be provided to protrude from an inner surface of the vacuum cleaner seating part 131. The first charging terminal 133 may be disposed to be electrically connected to the first battery 19 installed in the vacuum cleaner 10 when the vacuum cleaner 10 is held and stored by the holder 130. The first charging terminal 133 may provide power, which is received from the first power adapter 116, to the first battery 19. The power converted by the first power adapter 116 may be supplied to the first charging terminal 133 through the wires 101a, 101b, 101c, and 101d.

While the specific embodiments of the preset invention have been illustrated and described above in detail, the embodiments may be variously modified by those skilled in the art without departing from the gist of the technological scope of the present invention defined by the appended claims.

1. A vacuum cleaner holding apparatus comprising:
a holder including a first charging terminal provided to be electrically connectable to a vacuum cleaner in which a first battery is installed;
a base which includes a second charging terminal provided to be electrically connectable to a second battery and accommodates a first power adapter provided to supply power to the first charging terminal and a second power adapter provided to supply power to the second charging terminal; and
a support which connects the holder and the base and in which a hollow is formed.

2. The vacuum cleaner holding apparatus of claim 1, wherein wires, which electrically connect the first power adapter and the first charging terminal, are disposed in the hollow of the support.

3. The vacuum cleaner holding apparatus of claim 2, wherein:
the holder includes a first connecting device connected to the support; and
the first connecting device includes a first wire guide which guides at least some of the wires passing through the hollow and extending to the holder.

4. The vacuum cleaner holding apparatus of claim 2, wherein:
the base includes a second connecting device connected to the support; and
the second connecting device includes a second wire guide which guides at least some of the wires extending from the base to the hollow.

5. The vacuum cleaner holding apparatus of claim 1, wherein the second power adapter is provided to be driven independently of the first power adapter.

6. The vacuum cleaner holding apparatus of claim 1, wherein the support extends in a direction oblique to a bottom surface on which the base is disposed.

7. The vacuum cleaner holding apparatus of claim 6, wherein the support extends upward from an edge of an upper surface of the base toward a center of the base.

8. The vacuum cleaner holding apparatus of claim 1, wherein a printed circuit board configured to control the first power adapter and the second power adapter is disposed in the base.

9. The vacuum cleaner holding apparatus of claim 1, wherein the base includes a weight balancer provided to increase a weight of the base.

10. The vacuum cleaner holding apparatus of claim 1, wherein the base includes a battery accommodation part in which the second battery is accommodated to be electrically connected to the second charging terminal.

11. The vacuum cleaner holding apparatus of claim 1, wherein the holder includes a guide seating part which guides the first battery installed in the vacuum cleaner to a position at which the first battery is electrically connected to the first charging terminal when the vacuum cleaner is seated on the vacuum cleaner holding apparatus.

12. The vacuum cleaner holding apparatus of claim 1, wherein the support includes a connecting port provided to store an auxiliary suction unit of the vacuum cleaner.

13. The vacuum cleaner holding apparatus of claim 1, further comprising a power cable which is provided to be connectable to the base to supply the power to the first power adapter and the second power adapter and of which one end opposite to the other end connected to the base is connected to a plug for receiving a source voltage.

14. The vacuum cleaner holding apparatus of claim 1, wherein the base includes a suction unit seating part provided to allow a main suction unit installed in the vacuum cleaner to be seated on the suction unit seating part.

15. A vacuum cleaning apparatus comprising:
a vacuum cleaner provided to allow a main suction unit and a first battery to be installable in the vacuum cleaner; and
a vacuum cleaner holding apparatus on which the vacuum cleaner is held,
wherein the vacuum cleaner holding apparatus includes,
a holder including a first charging terminal provided to be electrically connectable to the vacuum cleaner in which the first battery is installed;
a base which includes a second charging terminal provided to be electrically connectable to a second battery and accommodates a first power adapter provided to supply power to the first charging terminal and a second power adapter provided to supply power to the second charging terminal; and
a support which connects the holder and the base and in which a hollow is formed.
